(19) United States
(12) Patent Application Publication
(10) Pub. No.: US 2025/0342707 A1
(43) Pub. Date: Nov. 6, 2025

(54) STORAGE MEDIUM, INFORMATION PROCESSING SYSTEM, AND INFORMATION PROCESSING METHOD

(71) Applicant: KONICA MINOLTA, INC., Tokyo (JP)

(72) Inventor: Takumi KASEDA, Kashiwa-shi (JP)

(73) Assignee: KONICA MINOLTA, INC., Tokyo (JP)

(21) Appl. No.: 19/185,413

(22) Filed: Apr. 22, 2025

(30) Foreign Application Priority Data
May 2, 2024 (JP) 2024-074592

(51) Int. Cl. G06V 20/70; G06T 7/10; G06V 10/74

(52) U.S. Cl. CPC G06V 20/70; G06T 7/10; G06V 10/761

(57) ABSTRACT

A non-transitory computer readable storage medium includes a program that causes a hardware processor on a computer to perform: acquiring a plurality of first semantic vectors generated based on a plurality of frame images of a moving image and at least one second semantic vector generated based on a text representing content of the moving image; calculating a similarity between each of the plurality of first semantic vectors and each of the at least one second semantic vector; and specifying, from among the plurality of first semantic vectors, the first semantic vector for which the similarity satisfying a predetermined condition has been calculated, and extracting, from among the plurality of frame images, the frame image used for generating the specified first semantic vector.

### BACKGROUND OF THE INVENTION

### Technical Field

The present invention relates to a storage medium, an information processing system, and an information processing method.

### Description of Related Art

Conventionally, a technique has been known for generating a shortened moving image by extracting a thumbnail image representing a moving image from among a plurality of frame images constituting the moving image or extracting a representative portion of the moving image (e.g., Japanese Unexamined Patent Publication No. 2014-33417). In such a technique, the frame image in which a pixel value is greatly changed is detected as the frame image corresponding to a scene break in the moving image, and is used as the thumbnail image or used to determine a division position of the moving image.

However, an important frame image that represents the moving image is often included in a portion with little change in pixel value in the middle of each scene. Therefore, the frame image corresponding to the scene break is not always the important frame image in the moving image. As described above, the above-described related art includes a problem that the important frame image in the moving image cannot be appropriately extracted.

### SUMMARY OF THE INVENTION

It is an object of the present invention to provide a storage medium, an information processing system, and an information processing method that can appropriately extract an important frame image from a moving image.

In order to achieve the above-described object, according to an aspect of the present invention, a non-transitory computer readable storage medium includes a program that causes a hardware processor on a computer to perform:
acquiring a plurality of first semantic vectors generated based on a plurality of frame images of a moving image and at least one second semantic vector generated based on a text representing content of the moving image;
calculating a similarity between each of the plurality of first semantic vectors and each of the at least one second semantic vector; and
specifying, from among the plurality of first semantic vectors, the first semantic vector for which the similarity satisfying a predetermined condition has been calculated, and extracting, from among the plurality of frame images, the frame image used for generating the specified first semantic vector.

According to another aspect, an information processing system includes:
a hardware processor,
wherein,
   the hardware processor acquires a plurality of first semantic vectors generated based on a plurality of frame images of a moving image and at least one second semantic vector generated based on text representing content of the moving image,
the hardware processor calculates a similarity between each of the plurality of first semantic vectors and each of the at least one second semantic vector, and
the hardware processor specifies, from among the plurality of first semantic vectors, the first semantic vector for which the similarity satisfying a predetermined condition has been calculated, and extracts, from among the plurality of frame images, the frame image used for generating the specified first semantic vector.

According to another aspect, an information processing method executed by a computer, the method including:
acquiring a plurality of first semantic vectors generated based on a plurality of frame images of a moving image and at least one second semantic vector generated based on text representing content of the moving image;
calculating a similarity between each of the plurality of first semantic vectors and each of the at least one second semantic vector; and
specifying, from among the plurality of first semantic vectors, the first semantic vector for which the similarity satisfying a predetermined condition has been calculated, and extracting, from among the plurality of frame images, the frame image used for generating the specified first semantic vector.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a block diagram illustrating a configuration of a document generating system;

FIG. 2 is a flowchart of document generation processing;

FIG. 3 is a view illustrating a document generation screen;

FIG. 4 is a diagram illustrating processing for generating image text data;

FIG. 5 is a diagram illustrating processing for generating audio text data;

FIG. 6 is a diagram illustrating the document generation screen on which a chapter setting is displayed;

FIG. 7 is a diagram illustrating the document generation screen on which a body text is displayed;

FIG. 8 is a flowchart illustrating a control procedure of illustration extraction processing;

FIG. 9 is a diagram illustrating processing of conversion to a first semantic vector;

FIG. 10 is a diagram illustrating processing of conversion to a second semantic vector;

FIG. 11 is a view illustrating a similarity map; and

FIG. 12 is a diagram illustrating a method of extracting the first semantic vector.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described with reference to the drawings. However, the scope of the invention is not limited to the illustrated examples.

### Configuration of Document Generating System

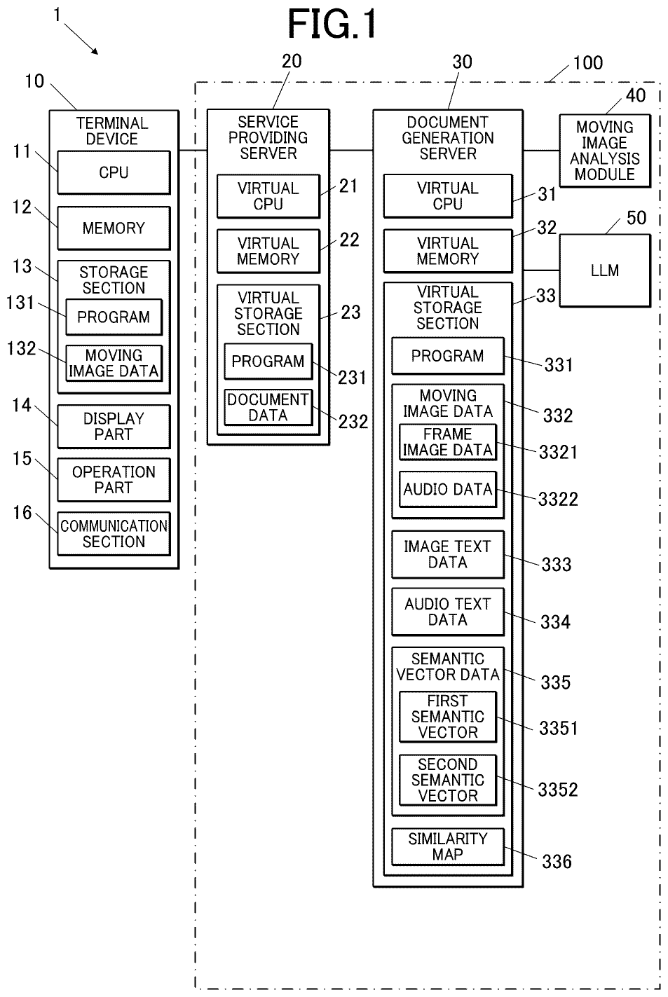

FIG. 1 is a block diagram illustrating a configuration of a document generating system 1 (information processing system) according to an embodiment of the present invention. The document generating system 1 includes a terminal device 10 and a cloud computing system 100. The terminal device 10 and the cloud computing system 100 are communicably connected to each other via a communication network such as the Internet. The document generating system 1 provides a user of the terminal device 10 with a service of generating an electronic document (hereinafter, simply referred to as a “document”) and storing and viewing the document. Hereinafter, this service is referred to as a “document generation service”. The document may be, for example, a manual, an instruction manual, a document in which knowhow is described, or the like, and is not limited thereto. In the present embodiment, a case in which a manual for a coffee machine is generated by the document generating system 1 will be described as an example.

The terminal device 10 is, for example, a notebook PC, a desktop PC, a tablet terminal, or a smartphone. The terminal device 10 includes a central processing unit (CPU) 11, a memory 12, a storage section 13, a display part 14, an operation part 15, and a communication section 16. Each section of the terminal device 10 are connected to each other via a data transmission path such as a bus.

The CPU 11 is a processor that controls the operation of each unit of the terminal device 10 by executing various processes in accordance with a program 131 stored in the storage section 13. The memory 12 is, for example, a random access memory (RAM), provides a working memory space to the CPU 11, and stores temporary data. The storage section 13 includes a flash memory, a hard disk drive (HDD), a solid state drive (SSD), or the like. The storage section 13 stores the program 131, moving image data 132 used for generating a manual, and the like. The moving image data 132 may be generated by an imaging section (not illustrated) provided in the terminal device 10, or may be acquired from the outside of the terminal device 10. The program 131 includes a web browser. The CPU 11 causes the display part 14 to display various information and documents on the web browser on the basis of the data received from the cloud computing system 100.

The display part 14 includes a display device such as a liquid crystal display. The display part 14 displays various kinds of information and documents in accordance with control signals and image signals input from the CPU 11. The operation part 15 includes input means such as a mouse, a keyboard, a touch screen, and operation buttons. When an operation is performed on the input means, the operation part 15 outputs an operation signal corresponding to the operation to the CPU 11. The communication section 16 performs a communication operation according to a predetermined communication standard. Through the communication operation, the communication section 16 transmits and receives data to and from the service providing server 20 of the cloud computing system 100.

The cloud computing system 100 includes a service providing server 20, a document generation server 30, a moving image analysis module 40, and a large language model 50. Hereinafter, the large language model 50 is abbreviated as “LLM (Large Language Model) 50”. The service providing server 20 and the document generation server 30 are virtual servers. Specifically, the cloud computing system 100 includes a plurality of physical servers (not illustrated) communicably connected to each other. In the cloud computing system 100, a virtual environment in which a plurality of virtual servers can be logically constructed is implemented by the plurality of physical servers. The service providing server 20 and the document generation server 30 are virtual servers constructed in such a virtual environment. Each of the virtual CPU, the virtual memory, and the virtual storage section included in the virtual server is realized by logically dividing or integrating the CPU, the memory, the storage section, and the like constituting the physical server.

The service providing server 20 includes a virtual CPU 21, a virtual memory 22, and a virtual storage section 23. The virtual CPU 21 executes various processes related to providing the document generation service in accordance with the program 231 stored in the virtual storage section 23. The virtual memory 22 provides a working memory space for the virtual CPU 21 and stores temporary data. The virtual storage section 23 stores a program 231, document data 232 generated by the document generation service, and the like.

In response to a request from the terminal device 10, the virtual CPU 21 performs various processing involving providing the document generation service and sends the processing results and the generated document data 232 to the terminal device 10. The processes performed by the virtual CPU 21 include a process of receiving information specifying the specifications and content of the document to be generated from the terminal device 10, a process of causing the document generation server 30 to generate the document data 232 on the basis of the received information, a process of causing the display part 14 of the terminal device 10 to display the document corresponding to the generated document data 232, and a process of managing the generated document data 232. As described above, the information that specifies the specification and the content of the document and that the service providing server 20 receives from the terminal device 10 includes the moving image data 132.

The document generation server 30 includes a virtual CPU 31 (hardware processor), a virtual memory 32, and a virtual storage section 33. The virtual CPU 31 executes various processes related to generation of the document data 232 in accordance with a program 331 stored in the virtual storage section 33. The virtual CPU 31 functions as an acquirer, a similarity calculator, and an extractor by executing various processing in accordance with the program 331. The virtual CPU 31 serving as the acquirer acquires a first semantic vector 3351 and a second semantic vector 3352 which will be described later. The virtual CPU 31 as the similarity calculator calculates the similarity between the first semantic vector 3351 and the second semantic vector 3352 to generate a similarity map 336. The virtual CPU 31 as an extractor extracts a frame image appropriate as an illustration of the manual on the basis of a calculation result of the similarity. The contents of these processes by the virtual CPU 31 will be described in detail later.

The virtual memory 32 provides a working memory space for a virtual CPU 31 and stores temporary data. The virtual storage section 33 stores the program 331 and various types of data used to generate the document data 232. Specifically, the virtual storage section 33 stores moving image data 332, image text data 333, audio text data 334, the semantic vector data 335, the similarity map 336, and the like. Of these, the moving image data 332 is data to be transmitted from the terminal device 10 via the service providing server 20, and the content thereof is the same as that of the moving image data 132. The moving image data 332 includes frame image data 3321 including image data of a plurality of frame images of a moving image, and audio data 3322 related to audio of the moving image. The contents of the image text data 333, the audio text data 334, the semantic vector data 335, and the similarity map 336 will be described later.

The process related to generating the document data 232 executed by the virtual CPU 31 includes a process of causing the moving image analysis module 40 to analyze the moving image data 332 and a process of causing the LLM 50 to generate a chapter setting and a body text of the document.

The moving image analysis module 40 executes analysis processing of moving image data, and outputs an execution result. The analysis processing by the moving image analysis module 40 can be called from any virtual server of the cloud computing system 100 and executed. Similarly to the virtual server, the moving image analysis module 40 includes a virtual CPU, a virtual memory, a virtual storage section, and the like (not illustrated), which form artificial intelligence (AI) for analyzing moving image data. The AI includes a machine learning model that has learned to extract analysis information from the moving image data and output the analysis information. For example, the moving image analysis module 40 recognizes and analyzes audio included in the audio data 3322 of the input moving image data 332, converts the audio into a text, and outputs the text. This processing is referred to as “transcription” of the audio of the moving image. In addition, in the present specification, the text acquired by transcribing the audio of the moving image is referred to as “audio text”. Further, the moving image analysis module 40 analyzes each frame image included in the frame image data 3321 of the moving image data 332, and outputs the text representing content of the frame image. In the present specification, the text representing the content of the frame image is referred to as “image text”. The image text is also referred to as a caption.

Reference numeral LLM 50 denotes a language model which has been learned in advance using a large amount of data and a deep learning technique so as to give a probability to an arrangement of words. The model parameter of a neural network is adjusted so that an appropriate probability is given to the arrangement of words in pre-learning by the deep learning technique. When a prompt which is an input sentence for instructing an operation of the LLM 50 is input, the LLM 50 estimates and outputs a sequence of words following the prompt, that is, a response sentence. Specifically, the LLM 50 divides the input prompt into minimum units called a token, and extracts a feature amount of the token. The LLM 50 constructs the response sentence by repeating processing of deriving the probability of the token following the prompt on the basis of the extracted feature amount. This operation allows the LLM 50 to perform various tasks requested by the prompt. The tasks executed by the LLM 50 of the present embodiment include a task of generating the chapter setting and the body text of the document on the basis of the input title, the audio text, and the like. Hereinafter, determining the configuration of a document including a plurality of chapters and generating chapter titles of the chapters will be referred to as “organizing by chapter setting”.

### Operation of Document Generating System

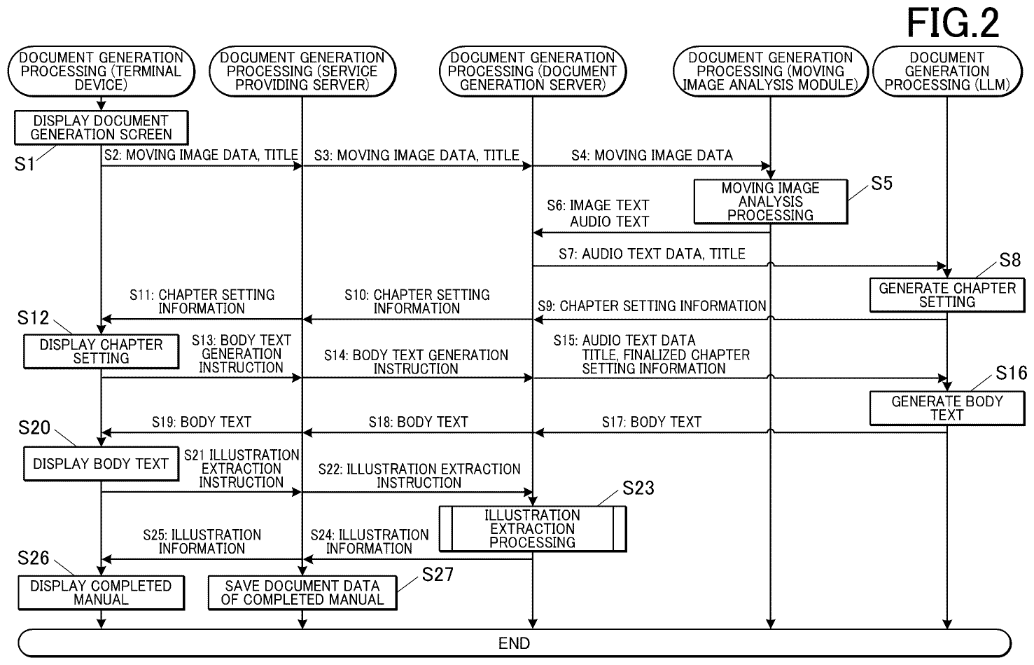

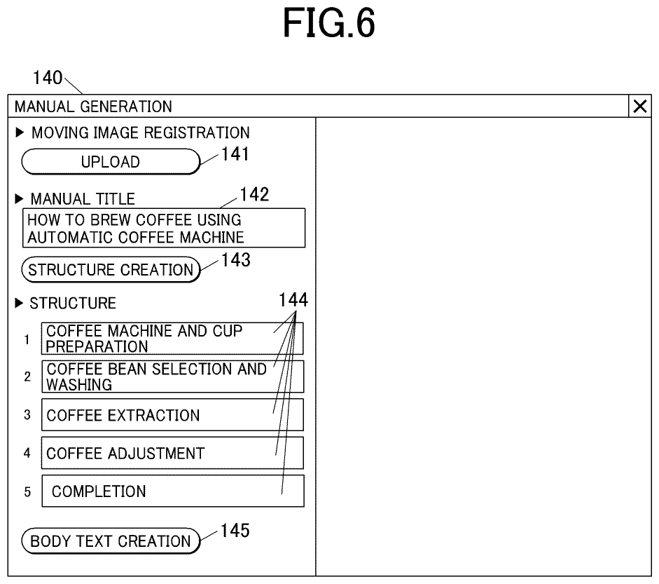

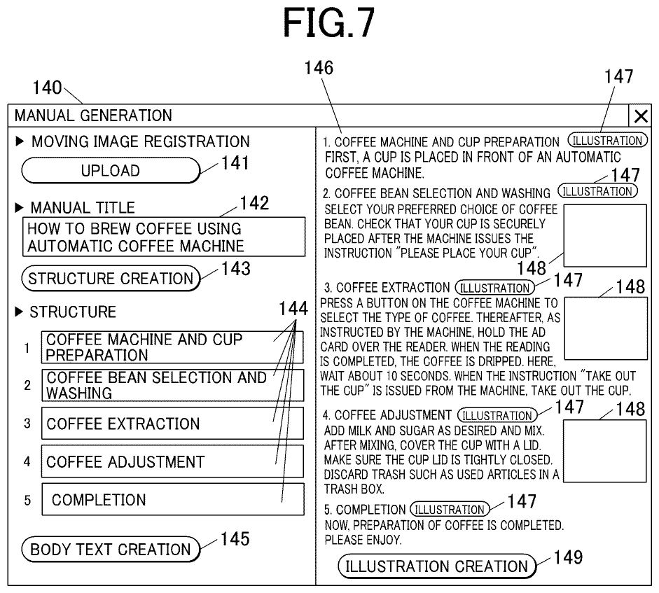

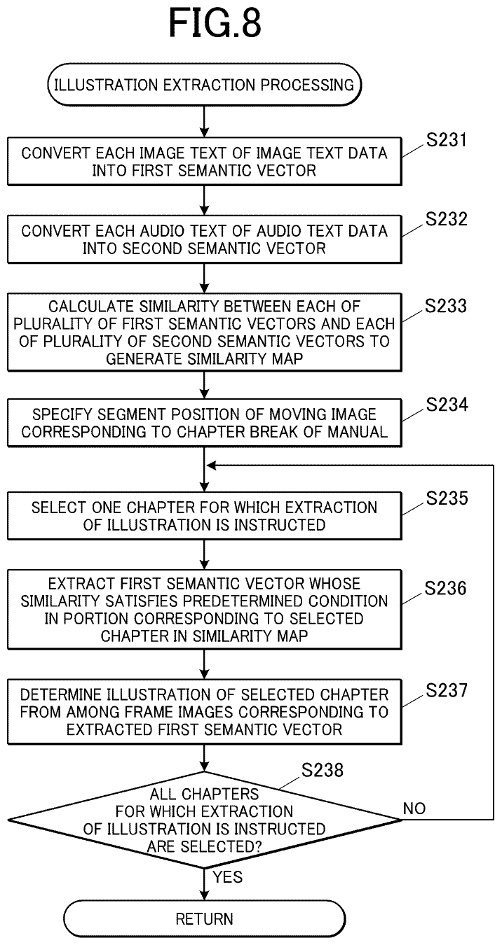

Next, the operation of the document generating system 1 will be described. FIG. 2 is a flowchart of document generation processing performed by each device of the document generating system 1 when the document generating system 1 generates the document for providing the document generation service. FIG. 2 illustrates processes to be executed by the CPU 11 of the terminal device 10, the virtual CPU 21 of the service providing server 20, the virtual CPU 31 of the document generation server 30, the moving image analysis module 40, and the LLM 50, respectively, and the flow of data transmission and reception between the apparatuses. The document generation processing roughly includes processing for generating the chapter setting of the manual (steps S1 to S12, FIG. 6), processing for generating the body text of the manual (steps S13 to S20, FIG. 7), and processing for extracting the illustrations to be inserted in the manual from the frame image data 3321 (steps S21 to S27, FIG. 8).

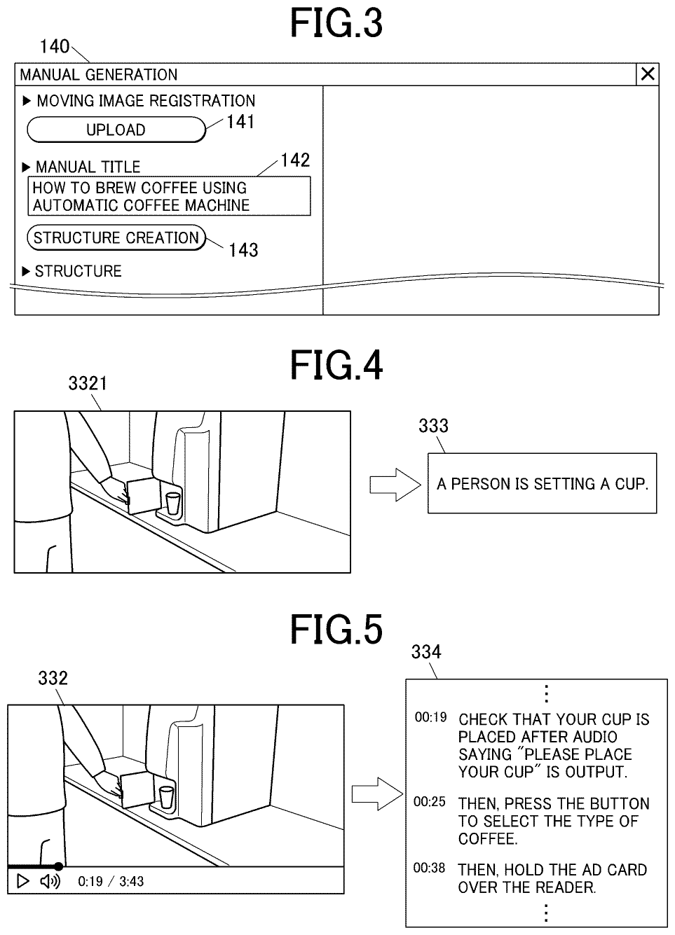

When the document generation processing is started, the CPU 11 of the terminal device 10 causes the display part 14 to display a document generation screen 140 shown in FIG. 3 (step S1). Specifically, when the user performs an input operation on the operation part 15 of the terminal device 10 to give an instruction to start document generation, the CPU 11 sends a request to start the document generation processing to the service providing server 20. The virtual CPU 21 of the service providing server 20 that has received the start request transmits data for causing the display part 14 to display the document generation screen 140 shown in FIG. 3 to the terminal device 10. The CPU 11 causes the display part 14 to display the document generation screen 140 shown in FIG. 3 on the web browser.

The document generation screen 140 illustrated in FIG. 3 displays an upload button 141 for registering the moving image data 332 to be used for generating the manual, a text box 142 for inputting the title of the manual, and a configuration creation button 143 for giving an instruction to create the configuration of the manual. When an operation of selecting the upload button 141 is performed, a window (not shown) for selecting the moving image to be registered is displayed. By selecting moving image data 1322 in the window and selecting a registration button (not shown), the moving image data 132 used for generating a manual can be registered. The CPU 11 sends the registered moving image data 132 to the service providing server 20. It is assumed that the moving image data 132 of the present embodiment is data of the moving image for demonstrating and explaining how to brew coffee using the coffee machine with an explanatory audio.

The user also enters the title of the manual to be generated in the text box 142. In FIG. 3, “How To Brew Coffee Using Automatic Coffee Machine” is input as the title.

When an operation of selecting the configuration creation button 143 is performed in a state in which the moving image data 132 is registered by the upload button 141 and the title is input in the text box 142, the processing of steps S2 to S12 in FIG. 2 for generating a manual chapter setting is executed. First, the CPU 11 sends the moving image data 132 and title data to the service providing server 20 (step S2). The virtual CPU 21 of the service providing server 20 transmits the received data to the document generation server 30 (step S3), and instructs the document generation server 30 to generate the manual chapter setting.

The virtual CPU 31 of the document generation server 30 causes the virtual storage section 33 to store the received moving image data 132 as the moving image data 332 and transmits the moving image data 332 to the moving image analysis module 40 (step S4). The moving image analysis module 40 performs analysis processing on the received moving image data 332 (step S5). The analysis processing includes processing for generating the image text data 333 on the basis of the frame image data 3321 of the moving image data 332 and processing for transcribing the audio data 3322 of the moving image data 332 to generate the audio text data 334.

FIG. 4 is a diagram illustrating a process of generating image text data 333. On the left side of FIG. 4, one frame image in the frame image data 3321 of the moving image data 332 is illustrated. The moving image analysis module 40 executes predetermined image recognition processing on the frame image to identify the type of an object, the motion of a person, and the like included in the frame image. The moving image analysis module 40 generates the image text representing the content of the frame image based on the identification result. In the example illustrated in FIG. 4, the frame image indicates that a person standing in front of the coffee machine places a cup on the coffee machine. The moving image analysis module 40 analyzes this frame image and generates the image text with the content “A person is setting a cup.” The moving image analysis module 40 performs this processing on each frame image to generate a plurality of image texts representing the content of each of the plurality of frame images included in the frame image data 3321. The moving image analysis module 40 generates the image text data 333 including the plurality of image texts. In the image text data 333, each of the plurality of image texts and a position in the moving image related to the moving image data 332 are registered in an associated manner. The position in the moving image is represented by, for example, a frame number, or an elapsed time from a start time point of the moving image. In a case in which the image text is the same over two or more consecutive frame images, these image texts may be combined into one in the image text data 333. In the image text data 333, the range of the moving image corresponding to the grouped moving image text, that is, the start point and the end point of the range may be registered in association with each other.

FIG. 5 is a diagram illustrating a process of generating the audio text data 334. The moving image regarding the moving image data 332 is illustrated on the left side of FIG. 5. The moving image analysis module 40 executes predetermined voice recognition processing on the audio data 3322 of the moving image, and identifies the content of the audio, that is, words spoken by a person. Based on the identification result, the moving image analysis module 40 converts the audio of the moving image into the audio text representing the content of the audio. In the example illustrated in FIG. 4, a person says a sentence “Check that your cup is placed after audio saying please place your cup is output.” in the moving image. The moving image analysis module 40 converts this sentence into the audio text. The moving image analysis module 40 executes this processing over the entire range of the moving image to generate the audio text of each of a plurality of sentences included in the audio data 3322. The moving image analysis module 40 generates the audio text data 334 including the audio texts of the plurality of sentences. In the audio text data 334, each of the audio texts of a plurality of sentences and a position in the moving image related to the moving image data 332, for example, a start position of a sentence are registered in an associated manner. The position in the moving image is represented by, for example, the frame number, or the elapsed time from the start time point of the moving image. In FIG. 5, the position of each audio text is represented by the elapsed time or the like from the start time point of the moving image. The audio text of the audio text data 334 is an aspect of “text representing the contents of the moving image”.

The moving image analysis module 40 sends the generated image text data 333 and audio text data 334 to the document generation server 30 (step S6 in FIG. 2). Note that a moving image analysis module that generates the image text data 333 and a moving image analysis module that generates the audio text data 334 may be separately provided.

The virtual CPU 31 of the document generation server 30 inputs the received audio text data 334 and the title data received from the service providing server 20 to the LLM 50, and causes the LLM 50 to generate the manual chapter setting (step S7). For example, the virtual CPU 31 inputs, to the LLM 50, the prompt with the content “Please arrange the following text in chapter settings” and titles and the audio text data 334. In response to this, the LLM 50 divides the content of the audio text data 334 into a plurality of chapters, and generates a chapter title for each chapter (step S8). The LLM 50 transmits the chapter setting information to the document generation server 30 (step S9). The chapter setting information includes the text of the chapter title of each chapter. The chapter setting information is transmitted to the terminal device 10 via the document generation server 30 and the service providing server 20 (steps S10 and S11).

Based on the received chapter setting information, as illustrated in FIG. 6, the CPU 11 of the terminal device 10 displays a manual chapter setting configuration in the left half of the document generation screen 140 (step S12). In FIG. 6, the chapter setting including chapters 1 to 5 of the manual is generated, and the chapter title of each chapter is displayed in a text box 144. The user can modify the chapter title as necessary. Furthermore, the CPU 11 causes a body text creation button 145 to be displayed together with the chapter setting configuration in the document generation screen 140.

In response to an operation of selecting the body text creation button 145 in the state of FIG. 6, an instruction to generate the body text of the manual is transmitted from the terminal device 10 to the service providing server 20 (step S13). The virtual CPU 21 of the service providing server 20 that has received the generation instruction transmits the body text generation instruction to the document generation server 30 (step S14). Furthermore, in a case where the chapter setting configuration has been changed in the text box 144, the determined chapter setting information after the change is also transmitted to the service providing server 20 and the document generation server 30.

The virtual CPU 31 of the document generation server 30 inputs the audio text data 334, the title, and the confirmed chapter setting information to the LLM 50, and causes the LLM 50 to generate the body text of the manual (step S15). For example, the virtual CPU 31 inputs, to the LLM 50, the prompt with the content “Please create the body text of the manual based on the text below”, and the audio text data 334, title, and the confirmed chapter setting information. In response to this, the LLM 50 generates the body text of the manual (step S16). Note that the audio text data 334 may be omitted, and the LLM 50 may be caused to generate the body text on the basis of the title and the determined chapter setting information. The LLM 50 transmits the generated body text information to the document generation server 30 (step S17). The body text information is transmitted to the terminal device 10 via the document generation server 30 and the service providing server 20 (steps S18 and S19).

Based on the received body text information, the CPU 11 of the terminal device 10 causes a body text 146 of the manual to be displayed in the right half of the document generation screen 140 as illustrated in FIG. 7 (step S20). Furthermore, the CPU 11 displays an illustration setting button 147 for each chapter in the body text 146. By performing an operation of selecting the illustration setting button 147 of a desired chapter, the user can set so that the illustration is inserted in the chapter. In FIG. 7, the illustration setting buttons 147 for the second chapter, the third chapter, and the fourth chapter are selected. In response to the selection of the illustration setting button 147, the CPU 11 displays a frame of an illustration region 148 in which an illustration is inserted at the right end of the corresponding chapter of the body text 146. Furthermore, when one or more illustration setting buttons 147 are selected, the CPU 11 causes an illustration creation button 149 to be displayed below the body text 146.

When an operation of selecting the illustration creation button 149 is performed in the state of FIG. 7, steps S21 to S25 for extracting an appropriate illustration from the frame image 3321 are executed. First, the CPU 11 of the terminal device 10 transmits an illustration extraction instruction to the service providing server 20 (step S21). In response, the virtual CPU 21 of the service providing server 20 transmits the illustration extraction instruction to the document generation server 30 (step S22). The virtual CPU 31 of the document generation server 30 that receives the illustration extraction instruction executes illustration extraction processing (step S23).

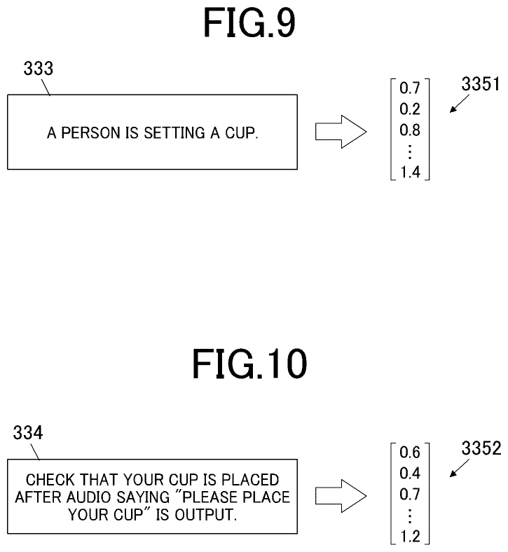

FIG. 8 is a flowchart illustrating a control procedure of the illustration extraction processing. When the illustration extraction processing is started, the virtual CPU 31 converts each image text in the image text data 333 into the first semantic vector 3351 (step S231). FIG. 9 is a diagram illustrating conversion processing into the first semantic vector 3351. As illustrated in FIG. 9, the virtual CPU 31 converts each image text in the image text data 333 into a first semantic vector 3351 having X vector elements according to a predetermined conversion rule. The number X of vector elements of the first semantic vector 3351 is, for example, several tens to several hundreds, but may be one thousand or more. Any conversion rule for the conversion into the first semantic vector 3351 can be defined freely as long as the content of the image text is reflected in the first semantic vector 3351. For example, the conversion processing into the first semantic vector 3351 may include the process of converting each of words and phrases included in the image text, such as “person”, “cup”, and “install”, into the vector having the number of elements X according to the predetermined conversion rule, the process of adding elements of a plurality of acquired vectors, and the like.

Subsequently, the virtual CPU 31 converts each audio text in the audio text data 334 into the second semantic vector 3352 (step S232). FIG. 10 is a diagram illustrating the conversion processing into the second semantic vector 3352. As illustrated in FIG. 10, the virtual CPU 31 converts, according to a predetermined conversion rule, each audio text in the audio text data 334 into the second semantic vector 3352 having the same number X of elements as the first semantic vector 3351. The conversion to the second semantic vector 3352 is performed according to the same conversion rule as the conversion rule to the first semantic vector 3351.

The processing of converting the image text into the first semantic vector 3351 is an aspect of the processing of acquiring the first semantic vector 3351. The processing of converting the audio text into the second semantic vector 3352 is one aspect of the processing of acquiring the second semantic vector 3352. Steps S231 and S232 correspond to an “Acquiring step”. Note that the virtual CPU 31 may input the image text data 333 to a predetermined vector conversion module provided outside the document generation server 30 to convert the image text into the first semantic vector 3351, thereby acquiring the first semantic vector 3351. Furthermore, the virtual CPU 31 may input the audio text data 334 to the above-described vector conversion module to convert the audio text into the second semantic vector 3352 and acquire the second semantic vector 3352.

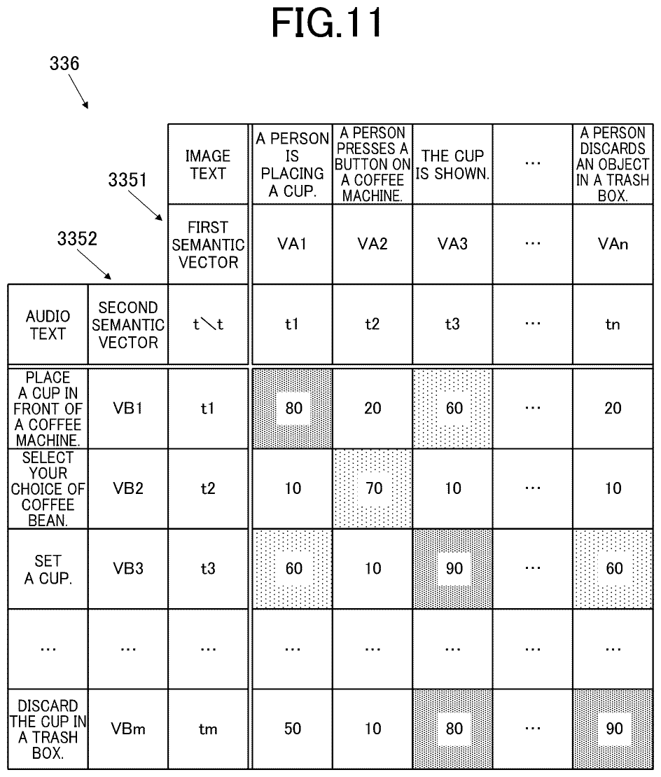

Subsequently, the virtual CPU 31 calculates the similarity between each of the plurality of first semantic vectors 3351 and each of the plurality of second semantic vectors 3352 to generate the similarity map 336 (step S233). Step S233 corresponds to a “similarity calculation step”. FIG. 11 is a view illustrating a similarity map 336. In FIG. 11, each image text of the image text data 333 is listed in a plurality of columns. Each of these image texts corresponds to one first semantic vector 3351. In FIG. 11, the first semantic vectors 3351 are denoted as “VA1” to “VAn”. Reference signs t1 to tn illustrated next to the respective first semantic vectors 3351 represent positions (time points) of the respective image texts in the moving image. Furthermore, in FIG. 11, the audio text of each sentence included in the audio text data 334 is described in a plurality of lines. Each of these audio texts corresponds to one second semantic vector 3352. In FIG. 11, the second semantic vectors 3352 are denoted by “VB1” to “VBm”. Reference signs t1 to tm illustrated next to each second semantic vector 3352 represent positions (time points) of the respective audio texts in the moving image.

A numerical value described in a cell where a column of the image text and a row of the audio text intersect each other represents the similarity between the first semantic vector 3351 corresponding to the image text and the second semantic vector 3352 corresponding to the audio text. Here, the similarity is normalized so that the minimum value is 0 and the maximum value is 100. The higher the similarity is, the more similar the first semantic vector 3351 and the second semantic vector 3352 are, that is, the more similar the semantic contents of the image text and the audio text are. In the example illustrated in FIG. 11, for example, the similarity between the audio text with the content “A cup is placed in front of a coffee machine” and the image text with the content “A person is placing a cup” whose semantic content is close to that of the audio text is high, that is, “80”. On the other hand, the similarity of this audio text to the image text that does not include the word “cup”, for example, the image text with the content “a person is pressing the button of a coffee machine” or “a person is throwing an object into a trash box” is low.

The similarity is calculated, for example, based on any one of the following values, a product (inner product) of the first semantic vector 3351 and the second semantic vector 3352, a Euclidean distance, a cosine distance, an angle formed by the vectors, and the maximum value of the difference between the components of the first semantic vector 3351 and the second semantic vector 3352, such that the similarity increases as the value decreases. For example, the similarity may be acquired by normalizing the reciprocal of the above-described value. In the actual data of the similarity map 336, the similarity may be associated with an arbitrary combination of the first semantic vector 3351 and the second semantic vector 3352, and the data of the audio text and the image text may be omitted.

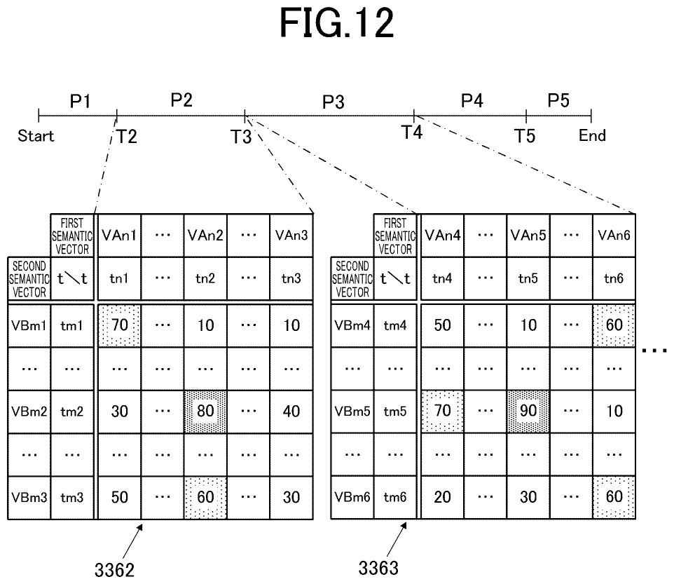

Referring back to FIG. 8, when the generation of the similarity map 336 is completed, the virtual CPU 31 specifies the section position of the moving image corresponding to the chapter setting of the manual (step S234). The bar illustrated in the upper half of FIG. 12 represents a period from the start time point to the end time point of the moving image according to the moving image data 332. Further, P1 to P5 respectively represent portions (partial moving images) corresponding to the first chapter to the fifth chapter of the manual illustrated in FIG. 7 in the moving image. Hereinafter, any one of the partial moving images P1 to P5 is referred to as a “partial moving image P”. Segment positions T2 to T5 are start time points of the partial moving images P2 to P5, respectively, and correspond to the segment positions when the moving image is segmented into the partial moving images P1 to P5. In step S234, the virtual CPU 31 identifies the segment positions T2 to T5, for example, based on the positions of the audio texts corresponding to the divisions of the respective chapters in the moving image when the audio text data 334 is organized into chapter settings by the LLM 50.

Referring back to FIG. 8, the virtual CPU 31 selects one chapter for which extraction of the illustration is instructed (step S235). In the example illustrated in FIG. 7, since extraction of illustrations for the second to fourth chapters is instructed, the virtual CPU 31 selects one of these chapters. Subsequently, the virtual CPU 31 extracts the first semantic vector 3351 whose similarity satisfies a predetermined condition in a portion (hereinafter, referred to as a “partial map”) corresponding to the selected chapter in the similarity map 336 (step S236). Step S236 corresponds to an “extraction step”.

FIG. 12 is a diagram illustrating a method of extracting the first semantic vector 3351. In step S236, the virtual CPU 31 refers to a partial map corresponding to the chapter selected in step S235 in the similarity map 336. This partial map is a portion of the similarity map 336 in which both the position of the first semantic vector 3351 in the moving image and the position of the second semantic vector 3352 in the moving image are included in the time range of the partial moving image P corresponding to the selected chapter. For example, FIG. 12 illustrates a partial map 3362 corresponding to the second chapter and a partial map 3363 corresponding to the third chapter. The time points tn1 to tn3 of the first semantic vector 3351 and the time points tm1 to tm3 of the second semantic vector 3352 in the partial map 3362 belong to the time range T2 to T3 of the partial moving image P2. In other words, the partial map 3362 is a portion of the similarity map 336 that represents the similarity between the image text and the audio text that belong to the partial moving image P2 corresponding to the second chapter. Furthermore, the time points tn4 to tn6 of the first semantic vector 3351 and the time points tm4 to tm6 of the second semantic vector 3352 in the partial map 3363 belong to the time range T3 to T4 of the partial moving image P3. In other words, the partial map 3363 is a part of the similarity map 336, which represents the similarity between the image text and the audio text belonging to the partial moving image P3 corresponding to the third chapter.

When selecting Chapter 2 in step S235, in step S236, the virtual CPU 31 identifies, from the partial map 3362, the first semantic vector 3351 whose similarity satisfies a predetermined condition. Here, the predetermined condition is satisfied when the similarity is within a predetermined number from the top in a case where the similarities in the partial map 3362 are arranged in descending order. For example, in a case where the predetermined number is set to “1”, the virtual CPU 31 identifies the first semantic vector 3351 corresponding to the highest similarity in the partial map 3362. In a case where the predetermined number is defined as “2 or more”, the virtual CPU 31 identifies a predetermined number of first semantic vectors 3351 corresponding to the predetermined number of highest degrees of similarity in the partial map 3362. As described above, by the method of specifying the first semantic vector 3351 having a high similarity in the partial map 3362, it is possible to specify the first semantic vector 3351 corresponding to the frame image having a high relevance to the content of the audio in the partial moving image P2.

Next, the virtual CPU 31 determines the illustration of the selected chapter from among the frame images corresponding to the extracted first semantic vector (step S237). For example, in step S236, in a case where one first semantic vector 3351 is specified for the second chapter, the virtual CPU 31 extracts the frame image used for generating the first semantic vector 3351 and determines the frame image as the illustration of the second chapter. Furthermore, when two or more first semantic vectors 3351 are specified for the second chapter, the virtual CPU 31 extracts two or more frame images used for generating the two or more first semantic vectors 3351. Next, the virtual CPU 31 selects one frame image from among the two or more extracted frame images by a predetermined method, and determines the selected frame image as the illustration of the second chapter. The method of selecting one frame image may be, for example, a method of causing the display part 14 of the terminal device 10 to display two or more extracted frame images and causing the user to select one desired frame image.

Note that in the partial map, the range of the first semantic vector 3351 corresponds to the time range of the partial moving image P, and the second semantic vector 3352 may include the second semantic vector 3352 of the entire range of the moving image. That is, the partial map may be acquired by narrowing the range of the first semantic vector 3351 in the similarity map 336. By using such a partial map, it is possible to extract, from the partial moving image P, the frame image highly relevant to the content of the audio of the entire moving image as the illustration.

Subsequently, the virtual CPU 31 determines whether all chapters for which the illustration extraction instruction has been given have been selected (step S238). If it is determined that any chapter has not been selected (“NO” in step S238), the virtual CPU 31 returns the process to step S235 and selects the next chapter. If it is determined that all the chapters for which the illustration extraction instruction has been issued have been selected (“YES” in step S238), the virtual CPU 31 ends the illustration extraction processing and returns the processing to the document generation processing in FIG. 2.

When the illustration extraction processing ends, the virtual CPU 31 transmits illustration information on the extracted illustration to the service providing server 20 (step S24). The virtual CPU 21 of the service providing server 20 transmits the received illustration information to the terminal device 10 (step S25). Here, the illustration information includes, for example, the frame number of the extracted frame image for each chapter for which extraction of the illustration has been instructed. Alternatively, the illustration information may include the image data itself including the extracted frame image.

Based on the received illustration information, the CPU 11 of the terminal device 10 causes the frame image extracted as the illustration to be displayed in the illustration region 148 for each chapter in FIG. 7. Thus, the completed manual is displayed on the document generation screen 140 (step S26). The virtual CPU 21 of the service providing server 20 stores the completed document data 232 of the manual in the virtual storage section 23 (step S27). When step S27 ends, each device of the document generating system 1 ends the document generation processing.

### Modification Example 1

Next, a modification example 1 of the embodiment will be described. Hereinafter, differences from the above-described embodiment will be described, and description of points common to the above-described embodiment will be omitted.

In the above-described embodiment, the audio text acquired by transcribing the audio data 3322 is used as the text representing the content of the moving image, and the audio text is converted into the second semantic vector 3352, but the text representing the content of the moving image is not limited to the audio text. For example, the text representing the content of the moving image may be the text that is input by the user in the terminal device 10 and that explains the content of the moving image. In addition, the text representing the content of the moving image may be the text acquired by transcribing audio describing the content of the moving image, which is different from the audio of the moving image. In addition, the text representing the content of the moving image may be the text acquired by predetermined analysis processing on the moving image, for example, the text acquired by summarizing the content of the moving image by AI including LLM.

### Modification Example 2

Next, modification example 2 of the embodiment will be described. Hereinafter, differences from the above-described embodiment will be described, and description of points common to the above-described embodiment will be omitted. Modification example 2 may be combined with modification example 1.

In the above embodiment, as shown in FIG. 11, the two dimensional similarity map 336 of two kinds of semantic vectors is used, but instead of this, an n-dimensional similarity map representing the similarity of n kinds of semantic vectors may be used. Here, n is a natural number equal to or greater than 3. The n types of semantic vectors include the first semantic vector 3351, the second semantic vector 3352, and at least one type of additional semantic vector. The additional semantic vector is generated on the basis of information (hereinafter referred to as “additional information”) that represents the content of the moving image regarding the moving image data 332 and that is different from any of the frame image data 3321 and the audio data 3322. The additional information may be, for example, a manual title that is entered into the text box 142 of FIG. 3. Furthermore, the additional information may be various kinds of texts representing the content of the moving image exemplified in modification example 1. Further, the additional information may be additional moving image information related to additional moving image data acquired by capturing the same object as that of the moving image data 332 from a different angle at the time of capturing the moving image data 332. The additional moving image information may be frame image data and/or audio data of the additional moving image data. If there is such additional information, the virtual CPU 31 converts the additional information into the additional semantic vector having the number X of elements in the same manner as the first semantic vector 3351 and the second semantic vector 3352.

In step S233 of FIG. 8, the virtual CPU 31 calculates the similarity of each combination of n types of semantic vectors including the first semantic vector 3351, the second semantic vector 3352, and at least one additional semantic vector, and generates the n-dimensional similarity map 336. The n-dimensional similarity map 336 is a map in which, at each position in an n-dimensional space, similarities of n types of semantic vectors corresponding to the position are registered. A method of calculating similarity in the n-dimensional similarity map 336 is not particularly limited as long as the method is a method in which similarity becomes greater as semantic content of each information corresponding to n types of semantic vectors is closer. For example, a method may be used in which a process of selecting one set of semantic vectors from n types of semantic vectors and calculating similarities is executed for all sets (for example, three sets in the case of three types of semantic vectors), and the acquired similarities are averaged. In addition, a method may be used in which a value such as the product (inner product), the Euclidean distance, or the cosine distance of one set of semantic vectors selected from n types of semantic vectors is calculated for all the sets, and a reciprocal of a representative value (for example, an average value) of the acquired values is normalized. Alternatively, the elements of n types of semantic vectors may be multiplied, and a value acquired by adding the acquired X products may be used in the same manner as the inner product to calculate the similarity.

In step S236 of FIG. 8, the virtual CPU 31 extracts, from among a plurality of similarities in an n-dimensional partial map that is a part of the n-dimensional similarity map 336, a first semantic vector 3351 whose similarity satisfies a predetermined condition. Note that in the case where the additional information corresponding to the additional semantic vector is information on additional moving image data, that is, in the case where there are two pieces of moving image data that can be referred to in the generation of the manual, frame images can be extracted from the two pieces of moving image data, respectively, for one similarity satisfying the predetermined condition. In this case, which frame image of the moving image data is used for the illustration or a method of determining which frame image of the moving image data is used for the illustration may be determined in advance. For example, which of the moving image data 332 and the additional moving image data is to be the moving image used for the illustration may be determined in advance. Alternatively, both the frame image of the moving image data 332 and the frame image of the additional moving image data may be used for the illustration. Alternatively, the frame images of the moving image data 332 and the frame images of the additional moving image data may be displayed on the display part 14 of the terminal device 10 so that the user can select a desired one of the frame images.

### Effect

As described above, the program 331 according to the present embodiment causes the virtual CPU 31 of the document generation server 30 as a computer to function as an acquirer, a similarity calculator, and an extractor. The virtual CPU 31 as an acquirer generates and acquires the plurality of first semantic vectors 3351 generated on the basis of the plurality of frame images of the moving image and the plurality of second semantic vectors 3352 generated on the basis of the audio text of the audio text data 334 representing the content of the moving image. The virtual CPU 31 as the similarity calculator calculates the similarity between each of the plurality of first semantic vectors 3351 and each of the plurality of second semantic vectors 3352. The virtual CPU 31 as the extractor identifies, among the plurality of first semantic vectors 3351, the first semantic vector 3351 for which the similarity satisfying a predetermined condition has been calculated. Furthermore, the virtual CPU 31 as the extractor extracts, from among the plurality of frame images, the frame image used to generate the identified first semantic vector 3351. When the degree of similarity between the first semantic vector 3351 and the second semantic vector 3352 satisfies a predetermined condition, the frame image corresponding to the first semantic vector 3351 and the audio text corresponding to the second semantic vector 3352 have high relevance. Therefore, according to the method of the present embodiment, it is possible to appropriately extract the important frame image having the high relevance with the content of the audio of the moving image. In other words, it is possible to appropriately extract the frame image of the scene corresponding to the content of the audio of the moving image. With the conventional method of extracting the frame image corresponding to the scene break, it was not possible to extract the important frame image in the middle of a scene, but with the method of the present embodiment, it is possible to appropriately extract the frame image at such a position.

The virtual CPU 31 as the acquirer acquires the plurality of second semantic vectors 3352 generated on the basis of the audio text acquired by converting the audio of the moving image. The audio of the moving image represents the content of the moving image. Therefore, by using the similarity to the second semantic vector 3352 acquired by converting the audio text, an important frame image highly relevant to the content of the moving image can be appropriately extracted.

Furthermore, in modification example 1, the virtual CPU 31 as the acquirer acquires the plurality of second semantic vectors 3352 generated on the basis of any of the text input by the user, the text acquired by converting the audio different from the audio of the moving image data 332, and the text acquired by predetermined analysis processing performed on the moving image data 332. Such text also represents the content of the moving image. Therefore, by using the similarity to the second semantic vector 3352 acquired by converting such text, the important frame image highly relevant to the content of the moving image can be appropriately extracted.

Furthermore, the virtual CPU 31 serving as the acquirer acquires, for each sentence of the audio text, the second semantic vector 3352 generated based on the sentence. Thus, the content of one sentence of the audio text can be appropriately reflected in the second semantic vector 3352. By calculating the similarity between such the second semantic vector 3352 and the first semantic vector 3351, it is possible to appropriately evaluate the degree of relevance between one sentence of the audio text and each frame image.

The virtual CPU 31 as the acquirer acquires the plurality of first semantic vectors 3351 generated on the basis of the plurality of image texts representing the content of the plurality of frame images. Thus, the content of the frame image can be appropriately reflected in the first semantic vector 3351.

In the modification example 2, the virtual CPU 31 serving as the acquirer acquires at least one type of additional semantic vector. The additional semantic vector is generated on the basis of additional information that represents the content of the moving image and that is different from any of the plurality of frame images of the frame image data 3321 and the audio text of the audio text data 334. Further, the virtual CPU 31 as the similarity calculator calculates the similarity of each combination of n kinds of semantic vectors including the first semantic vector 3351, the second semantic vector 3352, and at least one kind of additional semantic vector to generate the n-dimensional similarity map 336. Furthermore, the virtual CPU 31 serving as the extractor identifies the first semantic vector 3351 for which the similarity that satisfies a predetermined condition is calculated from among the plurality of similarities in the n-dimensional similarity map 336. Thus, it is possible to extract the frame image highly relevant to both the content of the audio text and the content of the additional information. Therefore, an important frame image can be extracted more appropriately.

In addition, the predetermined condition is satisfied when the calculated plurality of similarities are arranged in descending order and the similarity is within a predetermined number from the top. Thus, a predetermined number of important frame images can be extracted. Further, by setting the predetermined number to “1”, it is possible to extract one most important frame image.

Furthermore, the virtual CPU 31 as the extractor identifies, for each of the partial moving images P into which the moving image of the moving image data 332 is divided by a predetermined method, the first semantic vector 3351 for which the similarity satisfying the predetermined condition is calculated in each of the partial moving images P. Thus, an important frame image can be extracted for each partial moving image P. Therefore, it is possible to perform a process of extracting the frame image suitable for the illustration for each of a plurality of chapters of the manual.

The virtual CPU 31 as the extractor also acquires the segment position of the identified moving image on the basis of the content of the audio text in the audio text data 334 and identifies the partial moving image P on the basis of the segment position. Thus, the partial moving image P can be specified by appropriately dividing the moving image based on the audio text data 334.

Furthermore, the document generating system 1 according to the present embodiment includes the virtual CPU 31 that functions as the acquirer, the similarity calculator, and the extractor. The virtual CPU 31 as the acquirer generates and acquires the plurality of first semantic vectors 3351 generated on the basis of the plurality of frame images of the moving image and the plurality of second semantic vectors 3352 generated on the basis of the audio text of the audio text data 334 representing the content of the moving image. The virtual CPU 31 as the similarity calculator calculates the similarity between each of the plurality of first semantic vectors 3351 and each of the plurality of second semantic vectors 3352. The virtual CPU 31 as the extractor identifies, among the plurality of first semantic vectors 3351, the first semantic vector 3351 for which the similarity satisfying a predetermined condition has been calculated. Furthermore, the virtual CPU 31 as the extractor extracts, from among the plurality of frame images, the frame image used to generate the identified first semantic vector 3351. As a result, it is possible to appropriately extract the important frame image having high relevance to the content of the audio of the moving image.

Further, the information processing method according to the present embodiment includes an acquisition step, a similarity calculation step, and an extraction step. In the acquisition step, the virtual CPU 31 generates and acquires the plurality of first semantic vectors 3351 generated based on the plurality of frame images of the moving image and the plurality of second semantic vectors 3352 generated based on the audio text of the audio text data 334 representing the content of the moving image. In the similarity calculation step, the virtual CPU 31 calculates the similarity between each of the plurality of first semantic vectors 3351 and each of the plurality of second semantic vectors 3352. In the extraction step, the virtual CPU 31 identifies, from among the plurality of first semantic vectors 3351, the first semantic vector 3351 for which the similarity satisfying the predetermined condition has been calculated. Furthermore, in the extraction step, the virtual CPU 31 extracts, from among the plurality of frame images, the frame image used for the generation of the identified first semantic vector 3351. As a result, it is possible to appropriately extract the important frame image having high relevance to the content of the audio of the moving image.

Note that the present invention is not limited to the above embodiment, and various modifications are possible.

For example, the aspect in which the service providing server 20 and the document generation server 30 are virtual servers has been exemplified, but it is not intended to limit to this. The service providing server 20 and the document generation server 30 may be physical servers, that is, independent servers that actually exist.

Furthermore, although the aspect in which the document generation server 30 is provided with the virtual CPU 31 that functions as any of the acquirer, the similarity calculator, and the extractor has been described as an example, it is not limited to this aspect. Some or all of the acquirers, the similarity calculators, and the extractors may be provided in separate virtual servers or separate physical servers.

In addition, the processing executed by at least one of the moving image analysis modules 40 and LLM 50 may be executed by the document generation server 30.

Furthermore, the service providing server 20 and the document generation server 30 may be integrated.

Furthermore, although the audio text that corresponds to a single sentence in the audio text data 334 is converted into the single second semantic vector 3352 in the above embodiment, there is no limitation to this mode. For example, a group of audio for each predetermined time unit in the audio text data 334 may be converted into one second semantic vector 3352. Furthermore, a portion corresponding to one chapter in the audio text data 334 may be converted into one second semantic vector 3352. Furthermore, the entire audio text data 334 may be converted into one second semantic vector 3352. Therefore, there may be at least one second semantic vector 3352.

Furthermore, although the description has been given using the example in which the audio text data 334 is used to organize the manual into the chapter setting by the LLM 50, the method of generating the chapter setting for the manual is not limited thereto. For example, the manual chapter setting may be determined by a method in which a time point at which a pixel value of the frame image has greatly changed is set as the scene break in the moving image and the chapter is provided for each scene.

Furthermore, although the position at which the illustration is to be inserted is specified for each chapter in the manual in the present embodiment described above, this is not intended to be limiting. For example, the audio text of a certain sentence may be specified, and the illustration suitable for the sentence of the audio text may be extracted. In this case, in a row corresponding to the specified audio text in the similarity map 336 in FIG. 11 or the partial map in FIG. 12, the image text corresponding to the first semantic vector 3351 whose similarity satisfies the predetermined condition may be extracted. Further, one illustration may be extracted for the entire manual. In this case, the image text corresponding to the first semantic vector 3351 whose similarity satisfies the predetermined condition may be extracted using the entire similarity map 336 in FIG. 11 without using the partial map.

Further, the document generation processing shown in FIG. 2 is an example, and can be appropriately changed. For example, when generation of the body text is instructed after generation of the chapter setting, an insertion position of the illustration may be designated, and extraction of the illustration may be performed together with generation of the text. In addition, although an example in which the body text is generated after the chapter setting is generated has been described, instead of this, the chapter setting and the body text may be generated and displayed at the same time.

Although several embodiments of the present invention have been described, the scope of the present invention is not limited to the above-described embodiments, but encompasses the scope of the invention described in the claims and equivalents thereof.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2024-074592, filed on May 2, 2024, including description, claims, drawings and abstract is incorporated herein by reference.

What is claimed is:

1. A non-transitory computer readable storage medium comprising a program that causes a hardware processor on a computer to perform:
acquiring a plurality of first semantic vectors generated based on a plurality of frame images of a moving image and at least one second semantic vector generated based on a text representing content of the moving image;
calculating a similarity between each of the plurality of first semantic vectors and each of the at least one second semantic vector; and
specifying, from among the plurality of first semantic vectors, the first semantic vector for which the similarity satisfying a predetermined condition has been calculated, and extracting, from among the plurality of frame images, the frame image used for generating the specified first semantic vector.

2. The storage medium according to claim 1, wherein the text is an audio text acquired by converting audio of the moving image.

3. The storage medium according to claim 1, wherein the text is any one of the text input by a user, the text acquired by converting audio different from the audio of the moving image, and the text acquired by predetermined analysis processing on the moving image.

4. The storage medium according to claim 1, wherein the hardware processor acquires, for each sentence included in the text, the second semantic vector generated based on the sentence.

5. The storage medium according to claim 1, wherein the hardware processor acquires the plurality of first semantic vectors generated based on a plurality of image texts representing contents of each of the plurality of frame images.

6. The storage medium according to claim 1, wherein,
the hardware processor acquires at least one type of additional semantic vector generated based on information that represents the content of the moving image and that is different from any of the plurality of frame images and the text,
the hardware processor calculates a similarity of each combination of n types of semantic vectors consisting of the first semantic vector, the second semantic vector, and the at least one type of additional semantic vector to generate an n-dimensional similarity map, and
the hardware processor specifies the first semantic vector for which the similarity satisfying the predetermined condition is calculated among the plurality of similarities in the n-dimensional similarity map.

7. The storage medium according to claim 1, wherein the predetermined condition is satisfied in a case in which the similarity is within a predetermined number from beginning in a case in which the calculated plurality of similarities are arranged in descending order.

8. The storage medium according to claim 1, wherein the hardware processor specifies, for each part of the moving image divided by a predetermined method, the first semantic vector for which the similarity satisfying the predetermined condition is calculated in each part.

9. The storage medium according to claim 8, wherein the hardware processor acquires a segment position of the moving image specified based on a content of the text, and specifies the portion of the moving image based on the segment position.

10. An information processing system comprising:
a hardware processor,
wherein,
the hardware processor acquires a plurality of first semantic vectors generated based on a plurality of frame images of a moving image and at least one second semantic vector generated based on text representing content of the moving image,
the hardware processor calculates a similarity between each of the plurality of first semantic vectors and each of the at least one second semantic vector, and
the hardware processor specifies, from among the plurality of first semantic vectors, the first semantic vector for which the similarity satisfying a predetermined condition has been calculated, and extracts, from among the plurality of frame images, the frame image used for generating the specified first semantic vector.

11. An information processing method executed by a computer, the method comprising:
acquiring a plurality of first semantic vectors generated based on a plurality of frame images of a moving image and at least one second semantic vector generated based on text representing content of the moving image;
calculating a similarity between each of the plurality of first semantic vectors and each of the at least one second semantic vector; and
specifying, from among the plurality of first semantic vectors, the first semantic vector for which the similarity satisfying a predetermined condition has been calculated, and extracting, from among the plurality of frame images, the frame image used for generating the specified first semantic vector.
